(19) United States
(12) Patent Application Publication
(10) Pub. No.: US 2014/0097381 A1
(43) Pub. Date: Apr. 10, 2014

(54) ENHANCED CHEMICAL OXIDATION

(71) Applicant: Regenesis Bioremediation Products, San Clemente, CA (US)

(72) Inventors: BENJAMIN V. MORK, NEWPORT BEACH, CA (US); JOY M. GRAVITT, COSTA MESA, CA (US)

(73) Assignee: REGENESIS BIOREMEDIATION PRODUCTS, San Clemente, CA (US)

(21) Appl. No.: 14/049,410

(22) Filed: Oct. 9, 2013

Related U.S. Application Data
(60) Provisional application No. 61/711,613, filed on Oct. 9, 2012.

(51) Int. Cl. C02F 1/72; B09C 1/08; C09K 17/02

(52) U.S. Cl. CPC C02F 1/725; C09K 17/02; B09C 1/08
USPC 252/175; 252/186.1; 210/763; 405/263

(57) ABSTRACT

Compositions and methods for oxidizing contaminants present in environmental media. The compositions include a mixture of persulfate salts and borate salts to activate the persulfate's oxidation of contaminants.

### CROSS-REFERENCE TO RELATED APPLICATIONS

The present application claims priority to Provisional Patent Application Ser. No. 61/711,613, entitled ENHANCED CHEMICAL OXIDATION, filed on Oct. 9, 2012, all of the teachings of which are incorporated herein by reference.

### STATEMENT RE: FEDERALLY SPONSORED RESEARCH/DEVELOPMENT

Not Applicable

### BACKGROUND

Chemical oxidants are used widely in industrial applications and consumer products. Commercially useful oxidants include hydrogen peroxide, ozone, sodium percarbonate, sodium persulfate, sodium permanganate, and sodium perborate, among others. Most of the ionic oxidants, such as persulfates, are available with a variety of counterions, including sodium, potassium, ammonium, etc.

Persulfate (including peroxymonosulfate and peroxydisulfate) compounds are stable in the solid form and have utility in many applications including polymer manufacturing, printed circuit board (PCB) etching, hair bleaching, oil exploration and production, disinfection, and destruction of environmental contaminants. In Situ (in-place) detoxification of soil and groundwater by oxidants is commonly referred to as ISCO (In Situ Chemical Oxidation). The persulfate anion (S₂O₈²⁻) is a very strong oxidant that is known to oxidize many organic and inorganic materials by either direct oxidation or free radical processes.

Sodium persulfate has been used commercially to destroy organic contaminants in groundwater and soil, by both in situ and ex situ methods. When applied for environmental remediation, an activator or catalyst is typically added to enhance the reactivity of the persulfate toward oxidation of organic contaminants. Environmental contamination that can be remedied in this way includes organic solvents like trichloroethene (TCE), perchloroethene (PCE), dichloroethene (DCE), vinyl chloride (VC), as well as a wide variety of aliphatic and aromatic petroleum hydrocarbons including benzene, toluene, ethyl benzene, and xylenes. Oxygenates and other halogenated compounds can also be destroyed by activated sodium persulfate.

Activation methods that increase the reactivity of persulfate-based oxidants typically include thermal activation, alkaline activation, or metal catalysts (e.g., iron(II)). In the environmental remediation field, additional persulfate activation methods have been employed including activation by other oxidants such as hydrogen peroxide or permanganate.

There are limitations of the conventional persulfate activation options for environmental remediation. Only alkaline activation and thermal activation are generally accepted to oxidize nearly all of the common organic contaminants in groundwater. For example, the metal-based methods (e.g., iron) are known to be less effective on hydrocarbon contaminants.

Thermal persulfate activation is possible but very costly due to the large energy requirement associated with heating large volumes of soil and groundwater. In-situ thermal activation also requires installation of heating devices in the subsurface which can be costly or impractical at some sites.

Alkaline activation of persulfate involves mixing caustic materials like sodium hydroxide into the persulfate solution. Due to the high buffering capacity of many soils, large amounts of caustic are often required to elevate the groundwater pH into the desired range for persulfate activation (pH>10). The need for large quantities of caustic materials can be expensive. Furthermore, the concentrated caustic materials can cause burns and therefore they present a significant safety hazard to users. In addition, a pH of greater than 10 is significantly higher than the typical groundwater pH (6 to 8), and may be considered undesirable from the standpoint of environmental groundwater and drinking water quality.

In general, persulfate oxidation reactions result in the formation of bisulfate and/or sulfuric acid, which create acidic conditions that may be undesirable in groundwater or other systems. In order to maintain a mild pH condition it is desirable for an activated persulfate to contain a buffer that offsets the acid production.

There is a need for new compositions and methods to activate persulfate toward oxidation of organic compounds in soil and groundwater that overcomes the limitations of the prior art. In particular, it would be useful to have a persulfate activation technology that is safe to use, operates under mild or neutral pH conditions, and can effectively destroy the wide range of contaminants encountered in soil and groundwater.

### BRIEF SUMMARY

Compositions and methods have been developed for the oxidation of organic contaminants in environmental media (e.g. soil and water). The use of boron-based additives (borax or other borate salts) has been found to enhance the performance of persulfate in oxidation reactions. This invention presents advantages over the prior art in for example, safety, efficacy, and ease of use.

New compositions and methods have been developed to activate sodium persulfate for oxidation of contaminants in environmental media including soil and groundwater. In view of the prior art, it was desired to have methods and compositions to oxidize contaminants in soil and groundwater that are environmentally acceptable, with low toxicity; that are effective for destruction of a wide range of environmental organic contaminants (e.g., chlorinated solvents, petroleum hydrocarbons, etc.); that are safe to handle (mild or neutral pH, low risk of burns or other accidents in use); and that operate in and maintain a mild pH condition (5<pH<10).

To meet these needs, new compositions and methods were developed that utilize borate salts to enhance the oxidation performance of sodium persulfate. In particular, the mineral borax and its derivatives, having the general formula Na₂B₄O₇.xH₂O, have been found to activate persulfate toward oxidation of contaminants including both hydrocarbons and chlorinated solvents. It is expected that other borate salts with the general formula MₐB_{b}O_{c}.xH₂O (where M is a cation such as sodium, potassium, or ammonium, and x=0-10) will have similar effects on oxidation reactions with persulfate salts.

Borax, also typically known as sodium borate decahydrate, has the formula Na₂B₄O₇.10H₂O. This material is a naturally occurring substance that is mined in the southwestern region of the United States as well as other areas around the world where natural deposits are present. Borax and its derivatives are used in a variety of applications including detergents, insecticides, ceramics, glasses, and insulating materials. It is mined in large quantities and available at very low cost. Borax is a generally low toxicity, naturally occurring material. In the present disclosure, the use of “borax” is intended to also include partially and completely dehydrated sodium borate.

The borate-persulfate mixtures provide a number of benefits over the prior art. They have a mild pH, typically 8-9.2. The borate, in addition to accelerating oxidation reactions, provides a buffering effect to offset the acidity generated by persulfate oxidations. Solutions or solid mixtures of this invention are easy and safe to use compared with caustic solutions or high-temperature methods of activation in the prior art.

One embodiment of the present invention encompasses mixtures of borax or other borate salts in aqueous solution with persulfate to enhance the reactivity of persulfate toward oxidation of contaminants in wet soil, groundwater, or wastewater. It is anticipated that the borates will further enhance other oxidation processes based on persulfate.

The oxidation solution may contain between 0.01% and 70% of a persulfate salt and 0.001% and 70% of a borate salt, by weight. More preferably for environmental applications, the solution could contain between 0.5% and 50% of a persulfate salt and 0.01% and 50% of a borate salt.

Alternatively the borate-persulfate composition could be provided as a mixture of solids to be dissolved in water. In this case, the mixture could contain between 1 and 99.95% of a persulfate salt, and from 0.05 to 99% of a borate salt.

Another embodiment of the present invention envisions methods of oxidizing contaminants present in environmental media. These methods involve injecting an aqueous solution of a persulfate salt and a borate salt into contaminated environmental media, so that the aqueous solution can oxidize the organic contaminants present in the environmental media.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 shows the amount of oxidation of benzene with varying levels of borate in combination with persulfate over a seven day period; and

FIG. 2 shows the amount of oxidation of benzene with varying ratios of borate to persulfate over a three day period.

### DETAILED DESCRIPTION

The following examples demonstrate that addition of borate salts to persulfate solutions enhances the oxidation of organic compounds. As shown, the borates enhance oxidation of contaminants including hydrocarbons (e.g., benzene and toluene) and chlorinated solvents (e.g., PCE and TCE). It should be noted that the extent of the oxidation of benzene increases with increasing borate loading.

### Example 1

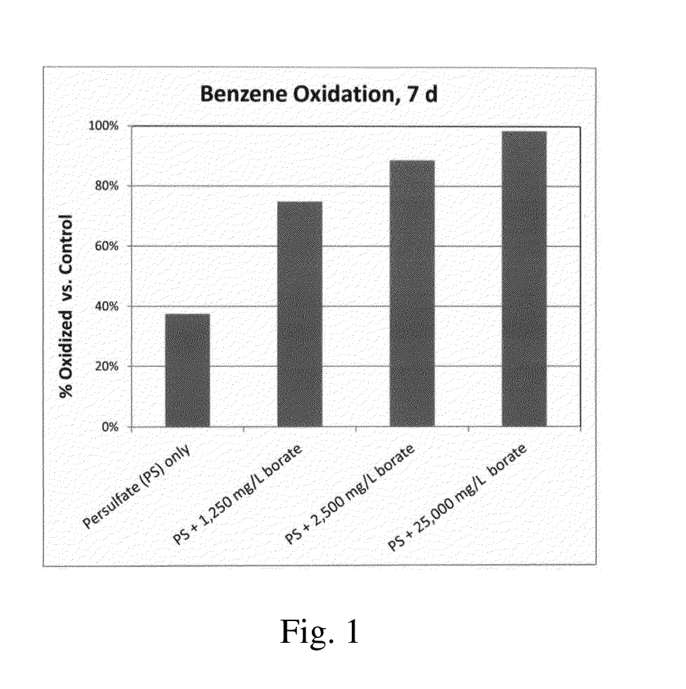

Five conditions were tested in airtight glass vials with polytetrafluoroethylene (PTFE)-lined caps. Each experiment began with approximately 200 mg/L benzene in 20 mL of water solution. The control condition contained only benzene in water. Four other conditions were tested with 0.1 M sodium persulfate (PS) added. These included persulfate only, and persulfate with sodium borate at 1,250 mg/L, 2,500 mg/L, and 25,000 mg/L as Na₂B₄O₇. After 7 days, the benzene concentration was measured in each solution, and the results are shown in FIG. 1. The control solution contained 195 mg/L of benzene, exhibiting little or no losses of benzene over the 7-day period. Sodium persulfate alone oxidized a small fraction of the benzene (38%), whereas the borate-amended samples exhibited enhanced oxidation of benzene, between 75% and 99% depending on the loading. Percentage of benzene oxidized increased as the loading of borate increased, demonstrating that the borate enhances the rate of oxidation of benzene by sodium persulfate.

### Example 2

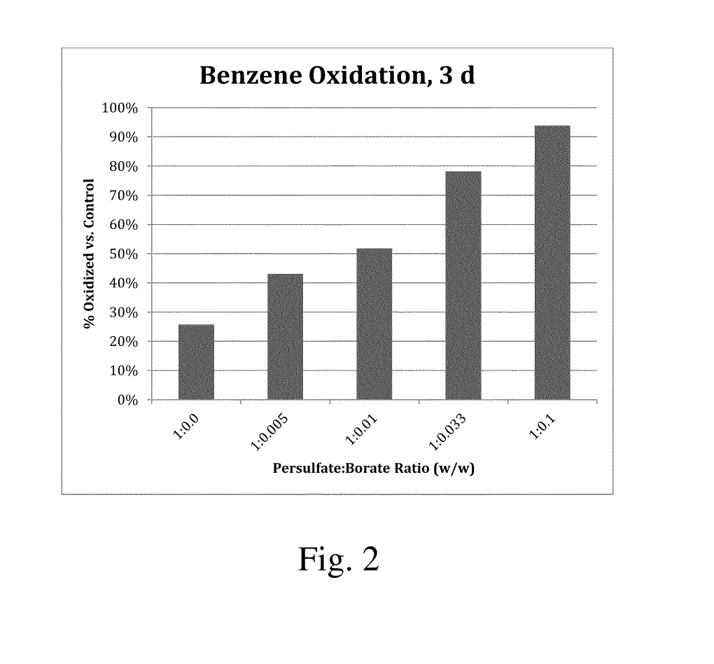

Six conditions were tested in airtight glass vials with PTFE-lined caps. Each experiment began with approximately 400 mg/L benzene in 20 mL of water solution. The control condition contained only benzene in water. Five other conditions were tested with 0.5 M sodium persulfate (PS) added. These included persulfate alone and persulfate with sodium borate (SB) at 595, 1,190, 3,570, and 11,900 mg/L as Na₂B₄O₇. These levels represent persulfate:borate weight ratios of 1:0, 1:0.005, 1:0.01, 1:0.033, and 1:0.1, respectively. After 3 days, the benzene concentration was measured in each solution, and the results are shown in Table 1 and FIG. 2. The control solution contained 418 mg/L of benzene, exhibiting little or no losses of benzene over the 3-day period. Sodium persulfate alone oxidized a small fraction of benzene (26%), whereas the borate-amended samples exhibited enhanced oxidation of benzene, between 43% and 94% depending on the loading. Percentage of benzene oxidized increased as the loading of the borate increase, demonstrating that the borate enhances the rate of oxidation of benzene by sodium persulfate.

TABLE 1
Contaminant Concentrations after 3 Days (mg/L)

| Sodium Persulfate | Final Benzene | Percentage |
|---|---|---|
| to Sodium | Concentration | of Benzene |
| Borate Ratio | (mg/L) | Oxidized vs. Control |
| 0:0 | 418 | — |
| 1:0 | 311 | 26% |
| 1:0.005 | 238 | 43% |
| 1:0.010 | 201 | 52% |
| 1:0.033 | 91 | 78% |
| 1:0.100 | 26 | 94% |

### Example 3

Oxidation trials of nine contaminants were tested in airtight glass vials with PTFE-lined caps. These contaminants were benzene, toluene, ethylbenzene, o-xylene, tetrachloroethylene (PCE), trichloroethylene (TCE), 1,4-dioxane, dichloroethane (DCA) and methyl tert-butyl ether (MTBE). Contaminant starting concentrations were individually selected within the range of 10 to 500 mg/L. Each control sample contained only the contaminant and water. The treated samples contained 0.5 M persulfate with sodium borate (SB) at 11,750 mg/L as Na₂B₄O₇. After 7 days, the contaminant concentration was measured in each solution. The results are reported in Table 2. Borate activated persulfate was able to oxidize over 90% of all contaminants versus control samples in 7 days.

TABLE 2
Contaminant Concentrations after 7 Days (mg/L)

| | | | Percentage of |
|---|---|---|---|
| | Final Control | Final Treated | Contaminant |
| Target | Concentration | Concentration | Oxidized vs. |
| Contaminant | (mg/L) | (mg/L) | Control |
| Benzene | 417 | 2 | 99% |
| Toluene | 159 | <1 | 99+% |
| Ethylbenzene | 19 | <1 | 94+% |
| o-Xylene | 33 | <1 | 96+% |
| PCE | 35 | <1 | 97+% |
| TCE | 205 | <1 | 99+% |
| 1,4-Dioxane | 30.5 | 0.005 | 99+% |
| MTBE | 9.4 | 0.006 | 99+% |
| DCA | 105 | 1 | 99% |

The above description is given by way of example, and not limitation. Given the above disclosure, one skilled in the art could devise variations that are within the scope and spirit of the invention disclosed herein, including various ratios of persulfate to borate, various methods of introducing the compositions of the present invention to contaminated environmental media, and further uses of increased oxidation with persulfate in other areas. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A chemical oxidation composition, said composition comprising an aqueous solution of a persulfate salt and a borate salt.

2. The composition of claim 1, wherein the persulfate salt is present in the amount of about 0.01% to about 70%, by weight, and the borate salt is present in the amount of about 0.001% to about 70%, by weight.

3. The composition of claim 2, wherein the persulfate salt is present in the amount of about 0.5% to about 50%, by weight, and the borate salt is present in the amount of about 0.01% to about 50%, by weight.

4. The composition of claim 1, wherein the persulfate salt is selected from the group consisting of sodium persulfate, potassium persulfate, ammonium persulfate, and peroxymonosulfates.

5. The composition of claim 1, wherein the borate salt is borax.

6. A system for oxidizing contaminants in soil and groundwater, said system comprising a mixture of solid persulfate salt and a borate salt.

7. The system of claim 6, wherein the persulfate salt is present in an amount of about 1% to about 99.95% and the borate salt is present in an amount of about 0.05% to about 99%.

8. The system of claim 6, wherein the persulfate salt is selected from the group consisting of sodium persulfate, potassium persulfate, ammonium persulfate, and peroxymonosulfates.

9. The system of claim 6, wherein the borate salt is borax.

10. A method of oxidizing contaminants present in environmental media, said method comprising injecting an aqueous solution of a persulfate salt and a borate salt into the environmental media.

11. The method of claim 10, wherein the environmental media is soil.

12. The method of claim 10, wherein the environmental media is groundwater.

13. The method of claim 10, wherein the persulfate salt is selected from the group consisting of sodium persulfate, potassium persulfate, ammonium persulfate, and peroxymonosulfates.

14. The method of claim 10, wherein the borate salt is borax.

15. The method of claim 10, wherein the persulfate salt is present in the amount of about 0.01% to about 70%, by weight, and the borate salt is present in the amount of about 0.001% to about 70%, by weight.

16. The method of claim 15, wherein the persulfate salt is present in the amount of about 0.5% to about 50%, by weight, and the borate salt is present in the amount of about 0.01% to about 50%, by weight.
